(19) United States
(12) Patent Application Publication
(10) Pub. No.: US 2026/0267090 A1
(43) Pub. Date: Sep. 10, 2026

(54) OPTICAL RECEPTACLE, OPTICAL MODULE, AND MANUFACTURING METHOD OF OPTICAL RECEPTACLE

(71) Applicant: Enplas Corporation, Saitama (JP)

(72) Inventors: Shimpei MORIOKA, Saitama (JP); Masanobu NATSUHARA, Saitama (JP); Akinobu SEKI, Saitama (JP); Yuki SAITO, Saitama (JP); Ayano HINATA, Saitama (JP); Kohei SONODA, Saitama (JP)

(73) Assignee: Enplas Corporation, Saitama (JP)

(21) Appl. No.: 19/557,159

(22) Filed: Mar. 5, 2026

(30) Foreign Application Priority Data
Mar. 6, 2025 (JP) 2025-035361

(51) Int. Cl. G02B 6/42

(52) U.S. Cl. CPC G02B 6/4214

(57) ABSTRACT

An optical receptacle is an optical receptacle for optically coupling a photoelectric conversion element and an end surface of an optical transmission member in a case where the optical receptacle is disposed between the photoelectric conversion element and the optical transmission member. The optical receptacle includes: an optical surface for allowing incidence thereon of light emitted from the photoelectric conversion element or the optical transmission member or for causing, to be emitted therefrom toward the end surface of the optical transmission member or the photoelectric conversion element, light having passed through an inside of the optical receptacle, the optical surface including a recessed portion and a protruding portion; an insert split line disposed to surround the optical surface; and a plurality of ejector pin marks disposed around a first region defined by the insert split line.

### CROSS REFERENCE TO RELATED APPLICATIONS

This application is entitled to the benefit of Japanese Patent Application No. 2025-035361, filed on Mar. 6, 2025, the disclosure of which including the specification, drawings and abstract is incorporated herein by reference in its entirety.

### TECHNICAL FIELD

The present invention relates to an optical receptacle, an optical module, and a manufacturing method of an optical receptacle.

### BACKGROUND ART

In recent years, a communication apparatus and a communication system including a photoelectric conversion element, an optical receptacle, and an optical fiber have been used in order to transmit and receive large-capacity data at a high speed using optical communication. In such optical communication, light emitted from the photoelectric conversion element is incident on the optical fiber via the optical receptacle (for example, see Patent Literature (hereinafter, referred to as “PTL” 1).

PTL 1 describes an optical component (optical receptacle) that is disposed between a laser light source (photoelectric conversion element) and an optical fiber (optical transmission member) and optically connects the laser light source and the optical fiber. The optical component includes a first convex lens for allowing incidence of light emitted from the laser light source, a second convex lens for causing the light incident on the first convex lens to be emitted toward the optical fiber, and a second optical surface for reflecting toward the second convex lens the light incident on the first convex lens. In addition, the optical component includes a pair of positioning protrusions for insertion into holes formed in a ferrule of the optical fiber to sandwich the second convex lens. The optical receptacle described in PTL 1 is manufactured by injection molding using an injection molding mold. Specifically, the injection molding mold includes a fixed-side mold and a movable-side mold. The fixed-side mold includes a second optical surface forming insert for forming a second optical surface side fixed to a fixed-side mold main body, and a slide core for forming a second convex lens side and a pair of positioning protrusion sides. The movable-side mold is used to form a first convex lens side.

### CITATION LIST

### Patent Literature

PTL 1
Japanese Patent Application Laid-Open No. 2018-81179

### SUMMARY OF INVENTION

### Technical Problem

Here, in the optical receptacle described in PTL 1, there is a case where it is demanded that an optical surface including a recessed portion and a protruding portion, such as a vortex surface, is provided. In this case, it is considered to form the second convex lens as an optical surface including a recessed portion and a protruding portion in consideration of deformation at the time of demolding, and to form the second convex lens with a slide core. However, in this case, it is necessary to form the second convex lens and the pair of positioning protrusions with the slide core. Since the slide core operates on the inclined surface and the force is dispersed in two directions, there is a concern that the central axis of the second convex lens may be misaligned. Further, there is a concern that the shape accuracy of the second convex lens may also be degraded due to the stress at the time of demolding.

An object of the present invention is to provide an optical receptacle having high position accuracy and shape accuracy of an optical surface including a recessed portion and a protruding portion. Another object of the present invention is to provide an optical module including the optical receptacle and a manufacturing method of the optical receptacle.

### Solution to Problem

The present invention relates to an optical receptacle, an optical module, and a manufacturing method of an optical receptacle as follow.
[1] An optical receptacle for optically coupling a photoelectric conversion element and an end surface of an optical transmission member in a case where the optical receptacle is disposed between the photoelectric conversion element and the optical transmission member, the optical receptacle including: an optical surface for allowing incidence thereon of light emitted from the photoelectric conversion element or the optical transmission member or for causing, to be emitted therefrom toward the end surface of the optical transmission member or the photoelectric conversion element, light having passed through an inside of the optical receptacle, the optical surface including a recessed portion and a protruding portion; an insert split line disposed to surround the optical surface; and a plurality of ejector pin marks disposed around a first region defined by the insert split line.
[2] The optical receptacle according to [1], in which a shape of the optical surface is formed by superposition of an aspherical component and a spiral component.
[3] An optical module, including: a photoelectric conversion element; an optical transmission member; and the optical receptacle according to claim 1, disposed between the photoelectric conversion element and the optical transmission member.
[4] A manufacturing method for manufacturing, by injection molding, an optical receptacle including an optical surface including a recessed portion and a protruding portion, the manufacturing method including: filling a cavity with a liquid material, the cavity being formed between a stationary mold and a movable mold, the stationary mold including a molding surface for molding the optical surface including the recessed portion and the protruding portion; and obtaining the optical receptacle by extruding a solidified material in the cavity with a plurality of ejector pins provided in the stationary mold.

### Advantageous Effects of Invention

According to the present invention, it is possible to provide an optical receptacle having high position accuracy and shape accuracy of an optical surface including a recessed portion and a protruding portion.

### BRIEF DESCRIPTION OF DRAWINGS

FIG. 1 is a diagram illustrating a configuration of an optical module according to the present embodiment;

FIGS. 2A to 2F are diagrams illustrating a configuration of an optical receptacle;

FIGS. 3A to 3D are diagrams illustrating a configuration of a first optical surface;

FIGS. 4A to 4F are diagrams illustrating another configuration of the first optical surface;

FIGS. 5A to 5C are schematic diagrams for describing an example of ejector pin marks;

FIGS. 6A to 6C are schematic diagrams for describing another example of the ejector pin marks;

FIGS. 7A to 7D are schematic diagrams for describing still another example of the ejector pin marks;

FIG. 8 is a sectional view of a mold; and

FIG. 9 is a flowchart of a manufacturing method of the optical receptacle.

### DESCRIPTION OF EMBODIMENTS

Hereinafter, an embodiment according to the present invention will be described in detail with reference to the drawings.

### (Configuration of Optical Module)

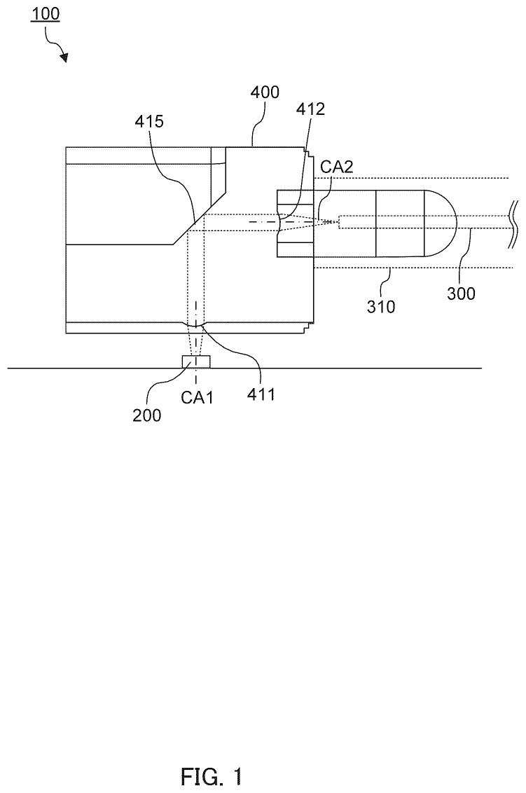

FIG. 1 is a diagram illustrating a configuration of optical module 100 according to an embodiment of the present invention.

As illustrated in FIG. 1, optical module 100 according to the present embodiment includes photoelectric conversion element 200, optical transmission member 300, and optical receptacle 400. In optical module 100, photoelectric conversion element 200 and optical transmission member 300 are optically coupled by optical receptacle 400.

Optical module 100 may be an optical module for transmission, an optical module for reception, or an optical module for transmission and reception. In a case where optical module 100 is an optical module for transmission, optical receptacle 400 guides light emitted from photoelectric conversion element 200 to an end surface of optical transmission member 300. On the other hand, in a case where optical module 100 is an optical module for reception, optical receptacle 400 guides light emitted from the end surface of optical transmission member 300 to photoelectric conversion element 200. Further, in a case where optical module 100 is an optical module for transmission and reception, a part of optical receptacle 400 guides light emitted from photoelectric conversion element 200 to the end surface of optical transmission member 300, and the remaining part of optical receptacle 400 guides light emitted from the end surface of optical transmission member 300 to photoelectric conversion element 200. In the present embodiment, optical module 100 is an optical module for transmission and reception.

In a case where optical module 100 is an optical module for transmission, photoelectric conversion element 200 is a light emitting element. The light emitting element is a light source that has a light emitting surface and emits light that reaches the end surface of optical transmission member 300. Examples of the light emitting element include a laser. Examples of the laser include a Vertical Cavity Surface Emitting Laser (VCSEL), a Distributed Feedback (DFB) laser, an Electro-absorption Modulated Laser (EML), and a fabry-perot laser.

In a case where optical module 100 is an optical module for reception, photoelectric conversion element 200 is a light receiving element. The light receiving element has a light receiving surface and receives light emitted from optical transmission member 300. The light receiving element is, for example, a photodetector.

In a case where optical module 100 is an optical module for transmission and reception, photoelectric conversion element 200 is a light emitting element and a light receiving element. In the present embodiment, since optical module 100 is an optical module for transmission and reception, photoelectric conversion element 200 has a light emitting element and a light receiving element. The number of light emitting elements and the number of light receiving elements are not particularly limited. In the present embodiment, photoelectric conversion element 200 has four light emitting elements and four light receiving elements.

Optical transmission member 300 receives light emitted from photoelectric conversion element 200 (light emitting element) or emits light toward photoelectric conversion element 200 (light receiving element). The type of optical transmission member 300 is not particularly limited. Examples of optical transmission member 300 include optical fibers and optical waveguides. In the present embodiment, optical transmission member 300 is an optical fiber. The optical fiber may be a single-mode fiber or a multi-mode fiber. In the present embodiment, the optical fiber is a multi-mode fiber.

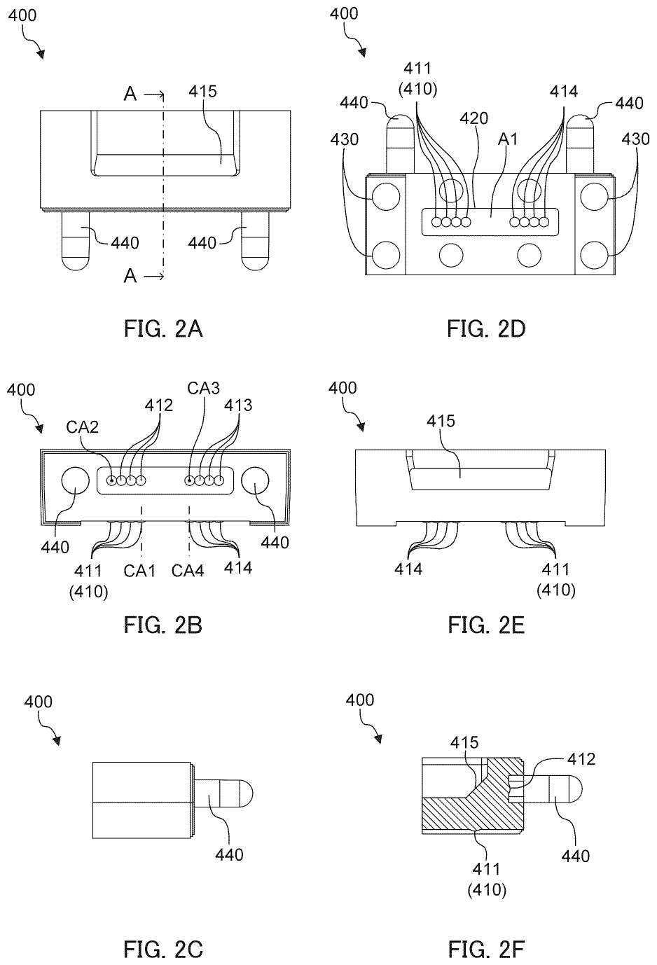

FIGS. 2A to 2F are diagrams illustrating a configuration of optical receptacle 400. FIG. 2A is a plan view of optical receptacle, FIG. 2B is a front view, FIG. 2C is a left side view, FIG. 2D is a bottom view, FIG. 2E is a rear view, and FIG. 2F is a cross-sectional view taken along line A-A illustrated in FIG. 2A.

Optical receptacle 400 is disposed between photoelectric conversion element 200 and optical transmission member 300 and optically couples photoelectric conversion element 200 and optical transmission member 300. It is preferable that optical receptacle 400 is formed of a material having light transmittance with respect to light having a wavelength used for optical communication. Examples of the material of optical receptacle 400 include a transparent resin such as polyetherimide (PEI) or a cyclic olefin resin. In addition, optical receptacle 400 is manufactured by injection molding.

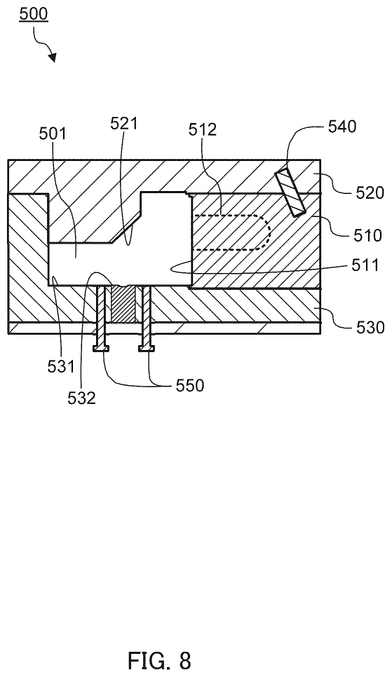

As illustrated in FIGS. 2A to 2F, optical receptacle 400 includes optical surfaces 410 including recessed portion 451 and protruding portion 452, insert split line 420, and a plurality of ejector pin marks 430. Optical surface 410, insert split line 420, and a plurality of ejector pin marks 430 result from molding by third mold 530, which is a stationary mold described later (see FIG. 8). In the present embodiment, optical surface 410 is disposed to face photoelectric conversion element 200.

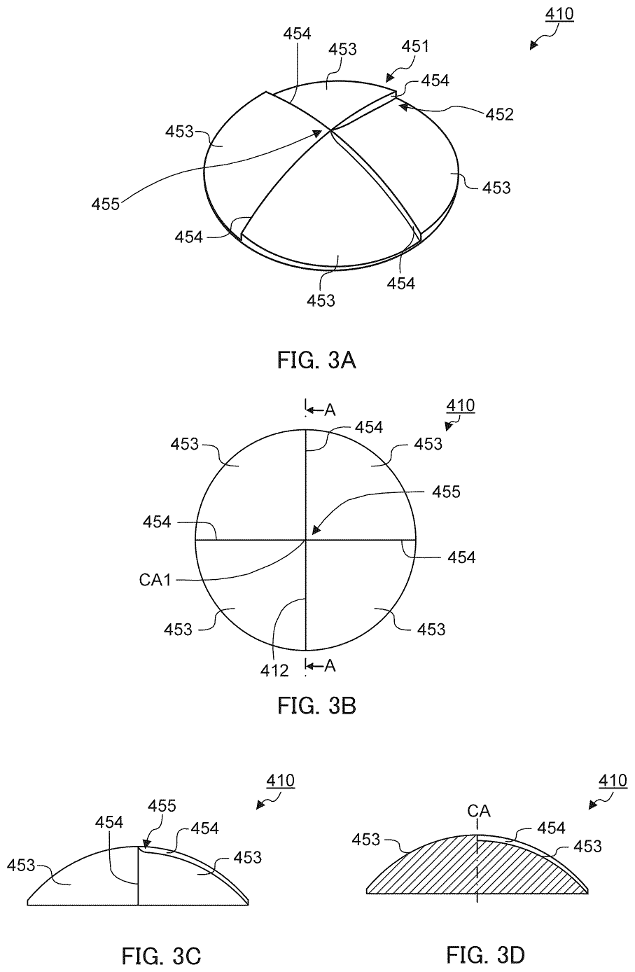

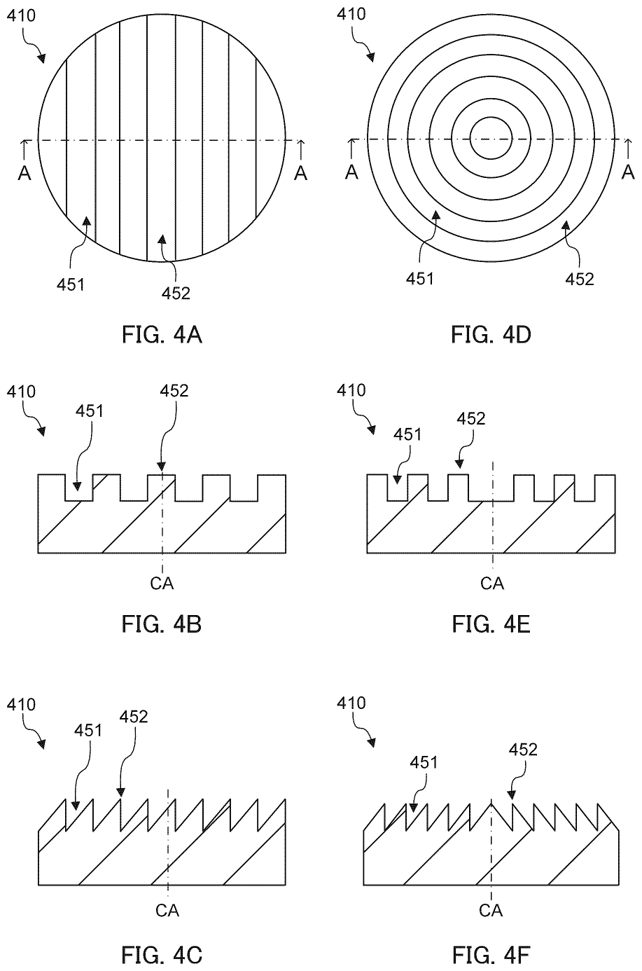

FIGS. 3A to 3D and FIGS. 4A to 4F are schematic diagrams illustrating a structure of optical surface 410. FIG. 3A is a perspective view of optical surface 410, FIG. 3B is a plan view, FIG. 3C is a side view, and FIG. 3D is a cross-sectional view taken along line A-A illustrated in FIG. 3B. In FIGS. 3A to 3D and FIGS. 4A to 4F, the shape of optical surface 410 is exaggerated to clarify the structural features of optical surface 410.

As illustrated in FIGS. 3A to 3D, the shape of optical surface 410 includes recessed portion 451 and protruding portion 452. It is preferable that the shape of each of optical surfaces 410 is formed by superimposing an aspherical component and a spiral component. When Gaussian light (for example, Gaussian beam) passes through optical surface 410, the Gaussian light is converted into vortex light (for example, vortex beam) having a ring-shaped intensity distribution.

The “aspherical component” is represented by the following Expression (1).

$$\begin{matrix}( Expression 1 ) & \\ Z = \frac{{cr}^{2}}{1 + 1 - ( 1 + k ) {c}^{2} {r}^{2}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} & [ 1 ]\end{matrix}$$

In Expression (1), c is a curvature (reciprocal of the curvature radius), k is a conic coefficient, r is a distance from the optical axis (the central axis of first optical surface 411), and α₁ to α₈ mean aspherical coefficients of the correction polynomial.

The “spiral component” is represented by the following Expression (2). The spiral component converts Gaussian light into vortex light.

$$\begin{matrix}( Expression 2 ) & \\ {Z}_{B} = d \times ( \frac{φ}{360} ) & [ 2 ]\end{matrix}$$

In Expression (2), φ is an angle in a range of 0 to 360°, and d means a phase discontinuity of the spiral component.

The spiral component is a component having a continuous or stepped helical shape.

As shown in FIGS. 3A to 3D, in the present embodiment, optical surface 410 has a helical shape centered on central axis CA and includes a plurality of phase control surfaces 453 that are radially divided around central axis CA and a plurality of stepped surfaces 454 that connect end portions of two adjacent phase control surfaces 453 among the plurality of phase control surfaces 453. In the present embodiment, in a direction along central axis CA, of a region formed by phase control surface 453 and stepped surface 454, a portion formed by an upper portion of stepped surface 454 and phase control surface 453 connected thereto is protruding portion 452, and a portion formed by a lower portion of stepped surface 454 and phase control surface 453 connected thereto is recessed portion 451.

Each of the plurality of phase control surfaces 453 has a helical shape centered on central axis CA of optical surface 410. Here, the helical shape may be a smoothly continuous helical shape or a stepped helical shape. The number of phase control surfaces 453 is not particularly limited. In the present embodiment, optical surface 410 includes a plurality (four) of phase control surfaces 453 that generate the same phase difference. The plurality (four) of phase control surfaces 453 are disposed to be rotationally symmetric (four-fold symmetric) around central axis CA. Therefore, the plurality of phase control surfaces 453 have the same shape and are disposed in the same height range. Here, the height in optical surface 410 means a position in the direction along central axis CA.

Each of the plurality of phase control surfaces 453 is a convex curved surface, and in a side view, a curve from central portion 455 of optical surface 410 toward an outer peripheral portion has an inflection point at central portion 455 of optical surface 410. That is, in a section including central axis CA, a curve that is a section of phase control surface 453 has an inflection point at central portion 455 of optical surface 410. More specifically, in the section including central axis CA, in a region other than central portion 455 of optical surface 410, phase control surface 453 has a smaller inclination (becomes closer to being perpendicular to central axis CA) as it approaches central axis CA, but at central portion 455 of optical surface 410, phase control surface 453 includes a portion where the inclination increases as it approaches central axis CA (the angle with respect to central axis CA decreases). Note that, even at central portion 455 of optical surface 410, this does not apply in the immediate vicinity of stepped surface 454.

The plurality of stepped surfaces 454 connect end portions of two adjacent phase control surfaces 453 to each other. In the present embodiment, each of the plurality of stepped surfaces 454 is a flat surface extending in the radial direction from central axis CA to the outer edge. The upper sides of the plurality of stepped surfaces 454 intersect with each other at central portion 455 of the vortex surface. The number of stepped surfaces 454 is the same as the number of phase control surfaces 453. In the example shown in the present embodiment, optical surface 410 includes four stepped surfaces 454. The plurality (four) of stepped surfaces 454 are disposed to be rotationally symmetric (four-fold symmetric) about central axis CA. Accordingly, the plurality (four) of stepped surfaces 454 have the same shape and are disposed in the same height range.

Note that, there may be one phase control surface 453 and one stepped surface 454.

FIG. 4A is a plan view of another example of optical surface 410, and FIG. 4B is a sectional view taken along line A-A shown in FIG. 4A. As shown in FIGS. 4A and 4B, optical surface 410 includes recessed portion 451 and protruding portion 452. In the example shown in FIGS. 4A and 4B, recessed portions 451 of optical surface 410 are linear recesses, and protruding portions 452 are linear protrusions. In the present embodiment, both the cross-sectional shape of each of the linear recesses in the extension direction and the cross-sectional shape of each of the linear protrusions in the extension direction are rectangular.

FIG. 4C is a cross-sectional view of another example of optical surface 410. Note that, since the plan view is the same as that in FIG. 4A, the illustration is omitted. As shown in FIGS. 4A and 4C, optical surface 410 includes recessed portions 451 and protruding portions 452. In the example shown in FIGS. 4A and 4C, recessed portions 451 of optical surface 410 are linear recesses, and protruding portions 452 are linear protrusions. In the present embodiment, both the cross-sectional shape of each of the linear recesses in the extension direction and the cross-sectional shape of each of the linear protrusions in the extension direction are triangular.

FIG. 4D is a plan view of another example of optical surface 410, and FIG. 4E is a cross-sectional view taken along line A-A shown in FIG. 4D. As shown in FIGS. 4D and 4E, optical surface 410 includes recessed portions 451 and protruding portions 452. In the example shown in FIGS. 4D and 4E, recessed portions 451 of optical surface 410 are annular recesses, and protruding portions 452 are annular protrusions. In the present embodiment, in a cross section including central axis CA, both the cross-sectional shape of each of the annular recesses and the cross-sectional shape of each of the annular protrusions are rectangular.

FIG. 4F is a cross-sectional view of another example of optical surface 410. The plan view is the same as that in FIG. 4D, and thus the illustration is omitted. As shown in FIGS. 4D and 4F, optical surface 410 includes recessed portions 451 and protruding portions 452. In the example shown in FIGS. 4D and 4F, recessed portions 451 of optical surface 410 are annular recesses, and protruding portions 452 are annular protrusions. In the present embodiment, in a cross section including central axis CA, both the cross-sectional shape of each of the recesses and the cross-sectional shape of each of the protrusions are triangular.

Since optical module 100 of the present embodiment is an optical module for transmission and reception, optical receptacle 400 is an optical receptacle for transmission and reception. Optical receptacle 400 of the present embodiment includes first optical surfaces 411, second optical surfaces 412, third optical surfaces 413, fourth optical surfaces 414, and reflecting surface 415. First optical surfaces 411, second optical surfaces 412, and reflecting surface 415 are used during transmission. Third optical surfaces 413, fourth optical surfaces 414, and reflecting surface 415 are used during reception. In the following description, a case where first optical surfaces 411 and fourth optical surfaces 414 are optical surface 410 according to the claims will be described.

Each of first optical surfaces 411 (optical surface 410) allows light emitted from photoelectric conversion element 200 to enter optical receptacle 400. First optical surface 411 is disposed to face photoelectric conversion element 200. It is preferable that first central axis CA1 of first optical surface 411 coincides with the central axis of the light emitting surface of photoelectric conversion element 200. The number of first optical surfaces 411 is the same as the number of light emitting elements. That is, in the present embodiment, the number of first optical surfaces 411 is four.

Reflecting surface 415 reflects light incident on first optical surface 411 toward second optical surface 412 or reflects light incident on third optical surface 413 toward fourth optical surface 414. Reflecting surface 415 is disposed on the optical path between first optical surface 411 and second optical surface 412 and on the optical path between third optical surface 413 and fourth optical surface 414. In the present embodiment, since optical module 100 is an optical module for transmission and reception, reflecting surface 415 reflects light incident on first optical surface 411 toward second optical surface 412 in a region (left region in FIG. 2A) that functions as a transmission region. On the other hand, in a region (right region in FIG. 2A) that functions as a reception region, reflecting surface 415 reflects light incident on third optical surface 413 toward fourth optical surface 414. The shape of reflecting surface 415 is not particularly limited as long as the above-described function can be exhibited. In the present embodiment, reflecting surface 415 is a flat surface and is inclined by 45° with respect to the traveling directions of light incident on first optical surface 411 and light incident on third optical surface.

Note that reflecting surface 415 may not be provided in optical receptacle 400. For example, first optical surface 411 and second optical surface 412 may be disposed at positions opposite to each other in optical receptacle 400, and light incident on first optical surface 411 may be emitted from second optical surface 412 without being reflected. In addition, third optical surface 413 and fourth optical surface 414 may be disposed at positions opposite to each other in optical receptacle 400, and light incident on third optical surface 413 may be emitted from fourth optical surface 414 without being reflected.

Second optical surface 412 emits light incident on first optical surface 411 and reflected by reflecting surface 415 toward optical transmission member 300. Second optical surface 412 is disposed to face optical transmission member 300. Second central axis CA2 of second optical surface 412 and the central axis of the end surface of optical transmission member 300 may or may not coincide with each other. The number of second optical surfaces 412 is the same as the number of optical transmission members 300. In the present embodiment, the number of second optical surfaces 412 is four. The shape of second optical surface 412 is not particularly limited as long as light reflected by reflecting surface 415 can be emitted toward optical transmission member 300, rather than optical surface 410 including recessed portion 451 and protruding portion 452. Second optical surface 412 may be a convex surface or a flat surface. In the present embodiment, second optical surface 412 is a convex surface.

Third optical surface 413 allows light emitted from optical transmission member 300 to enter optical receptacle 400. Third optical surface 413 is disposed to face the end surface of optical transmission member 300. It is preferable that third central axis CA3 of third optical surface 413 coincides with the central axis of the end surface of optical transmission member 300. The number of third optical surfaces 413 is the same as the number of optical transmission members 300. In the present embodiment, the number of third optical surfaces 413 is four. The shape of third optical surface 413 is not particularly limited as long as light emitted from optical transmission member 300 can be incident on optical receptacle 400, rather than optical surface 410 including recessed portions 451 and protruding portions 452. Third optical surface 413 may be a convex surface or a flat surface. In the present embodiment, third optical surface 413 is a convex surface.

Fourth optical surface 414 (optical surface 410) causes light incident on third optical surface 413 and reflected by reflecting surface 415 to be emitted toward photoelectric conversion element 200. Fourth optical surface 414 is disposed to face the light receiving surface of photoelectric conversion element 200 (light receiving element). It is preferable that fourth central axis CA4 of fourth optical surface 414 coincides with the central axis of the light receiving surface of photoelectric conversion element 200 (light receiving element). The number of fourth optical surfaces 414 is the same as the number of photoelectric conversion elements 200. In the present embodiment, the number of fourth optical surfaces 414 is four. The shape of fourth optical surface 414 is the same as that of first optical surface 411, and thus the description thereof will be omitted.

A pair of positioning protrusions 440 are disposed on a surface facing the end surface of optical transmission member 300, on which second optical surface 412 and third optical surface 413 are formed. Positioning protrusions 440 are connected to ferrule 310 that fixes optical transmission member 300. That is, in the present embodiment, first optical surface 411 (optical surface 410) is disposed on a surface facing photoelectric conversion element 200 on which a pair of positioning protrusions 440 is not disposed.

Insert split line (parting line) 420 is a line formed corresponding to a boundary line of a mold insert used in injection molding. Therefore, insert split line 420 is always formed in a case where optical receptacle 400 including optical surface 410 is manufactured by injection molding using a plurality of mold inserts. In general, since optical surface 410 is molded using a dedicated mold insert, insert split line 420 is formed around optical surface 410. In the present embodiment, insert split line 420 is disposed to surround first optical surface 411 and third optical surface 413. In the present specification, a region defined by insert split line 420 is referred to as first region A1. Here, “surrounding” means that insert split line 420 surrounds first optical surface 411 when viewed along first central axis CA1 of first optical surface 411. Therefore, first optical surface 411 and insert split line 420 may be disposed at the same height or may not be disposed at the same height. In the present embodiment, first optical surface 411 and insert split line 420 are disposed at the same height. The shape of first region A1 defined by insert split line 420 is not particularly limited. The shape of first region A1 may be a rectangle, a rounded quadrangle, a circle, or an ellipse.

Each of ejector pin marks 430 is a mark of an ejector pin that is formed on optical receptacle 400 by a mold in a case where optical receptacle 400 is manufactured by injection molding. The number of ejector pin marks 430 is not particularly limited as long as a plurality of ejector pin marks 430 are disposed around first region A1. Here, “around first region A1” means a region outside first region A1 on a surface on which first optical surface 411 is disposed. Note that the height of first region A1 and the height of the plurality of ejector pin marks 430 may be the same or different from each other. It is preferable that the plurality of ejector pin marks 430 are formed based on ejector pins 550 disposed such that optical receptacle 400 can be simultaneously released. As described above, in a case where a plurality of ejector pin marks 430 are disposed in a well-balanced manner with respect to first region A1, a force is applied to first region A1 in a well-balanced manner at the time of demolding, and thus the position accuracy of first optical surface 411 is high.

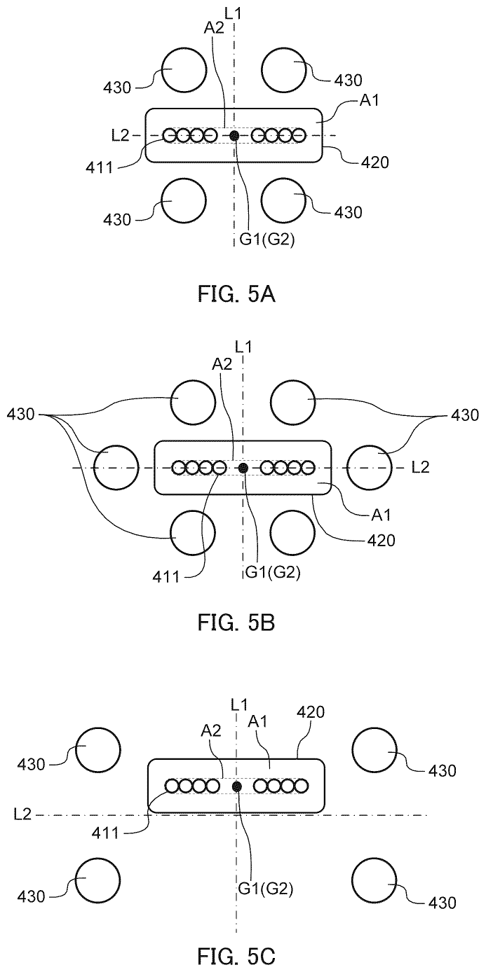

Here, the arrangement of ejector pin marks 430 will be described. FIGS. 5A to 5C are schematic diagrams for describing a positional relationship between insert split line 420 and ejector pin marks 430.

As shown in FIGS. 5A to 5C, the plurality of ejector pin marks 430 may be disposed at positions that are line-symmetrical with respect to first virtual straight line L1 passing through centroid G1 of first region A1 and second virtual straight line L2 perpendicular to first virtual straight line L1. Here, in the examples shown in FIGS. 5A and 5B, both first virtual straight line L1 and second virtual straight line L2 pass through centroid G1 of first region A1. On the other hand, in the example shown in FIG. 5C, first virtual straight line L1 passes through centroid G1 of first region A1, but second virtual straight line L2 does not pass through centroid G1 of the first region A1. In the present embodiment, first virtual straight line L1 extends in a direction perpendicular to the arrangement direction of first optical surfaces 411, and second virtual straight line L2 extends in a direction along the arrangement direction of first optical surfaces 411.

In addition, as shown in FIGS. 5A to 5C, the plurality of ejector pin marks 430 may be disposed at positions that are line-symmetrical with respect to first virtual straight line L1 passing through centroid G2 of second region A2 defined by the outer edge of first optical surfaces 411 and second virtual straight line L2 perpendicular to first virtual straight line L1. Here, in the examples shown in FIGS. 5A and 5B, both first virtual straight line L1 and second virtual straight line L2 pass through centroid G2 of second region A2. On the other hand, in the example shown in FIG. 5C, first virtual straight line L1 passes through centroid G2 of second region A2, but second virtual straight line L2 does not pass through centroid G2 of the second region.

In the examples shown in FIGS. 5A to 5C, centroid G1 of first region A1 and centroid G2 of second region A2 coincide with each other.

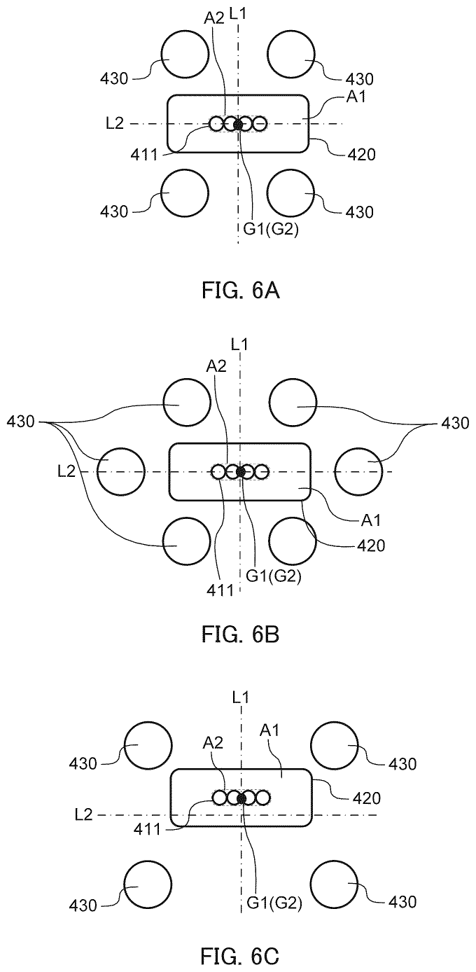

FIGS. 6A to 6C are schematic diagrams for describing a positional relationship between insert split line 420 and ejector pin marks 430 in a case where a plurality of optical surfaces 410 are provided in the optical receptacle for transmission or reception.

As shown in FIGS. 6A to 6C, the plurality of ejector pin marks 430 may be disposed at positions that are line-symmetrical with respect to first virtual straight line L1 passing through centroid G1 of first region A1 and second virtual straight line L2 perpendicular to first virtual straight line L1. Here, in the examples shown in FIGS. 6A and 6B, both first virtual straight line L1 and second virtual straight line L2 pass through centroid G1 of first region A1. On the other hand, in the example shown in FIG. 6C, first virtual straight line L1 passes through centroid G1 of first region A1, but second virtual straight line L2 does not pass through centroid G1 of the first region. In the present embodiment, first virtual straight line L1 is a direction perpendicular to the arrangement direction of first optical surface 411, and second virtual straight line L2 is a direction along the arrangement direction of first optical surface 411.

Further, as shown in FIGS. 6A to 6C, the plurality of ejector pin marks 430 may be disposed at positions that are line-symmetrical with respect to first virtual straight line L1 passing through centroid G2 of second region A2 defined by the outer edge of first optical surface 411 and second virtual straight line L2 perpendicular to first virtual straight line L1. Here, in the examples shown in FIGS. 6A and 6B, both first virtual straight line L1 and second virtual straight line L2 pass through centroid G2 of second region A2. On the other hand, in the example shown in FIG. 6C, first virtual straight line L1 passes through centroid G2 of second region A2, but second virtual straight line L2 does not pass through centroid G2 of the second region.

In the examples shown in FIGS. 6A to 6C, centroid G1 of first region A1 and centroid G2 of second region A2 coincide with each other.

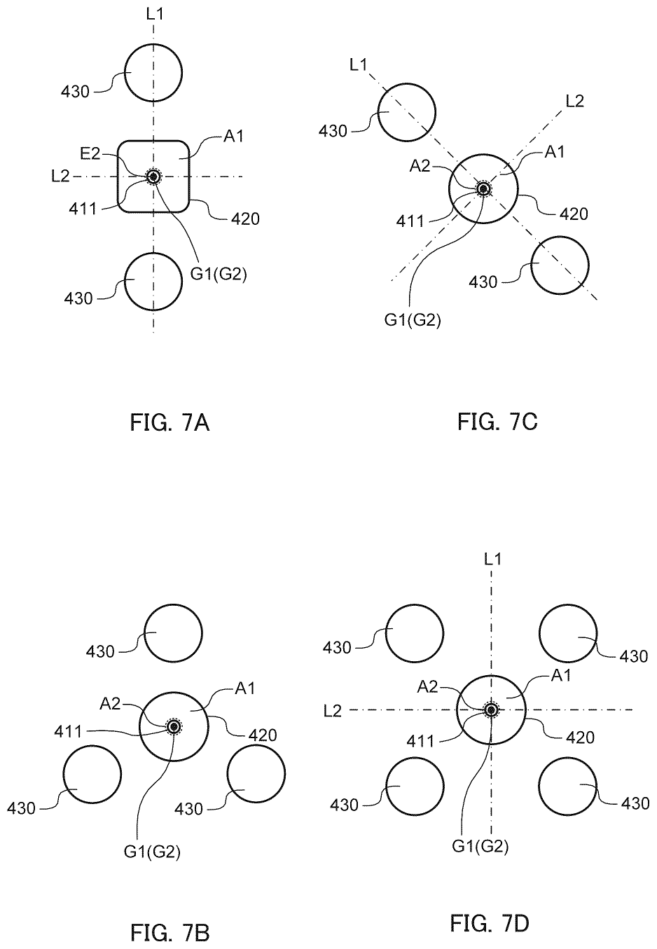

FIGS. 7A to 7D are schematic diagrams for describing a positional relationship between insert split line 420 and ejector pin marks 430 in a case where one optical surface 410 is provided in the optical receptacle for transmission or reception. FIG. 7A shows a case where insert split line 420 is a rounded quadrangle, and FIGS. 7B to 7D show a case where insert split line 420 is a circle.

As shown in FIGS. 7A and 7C, the plurality of ejector pin marks 430 may be disposed at positions that are line-symmetrical with respect to first virtual straight line L1 passing through centroid G1 of first region A1 and second virtual straight line L2 perpendicular to first virtual straight line L1. Further, the plurality of ejector pin marks 430 may be disposed at positions that are line-symmetrical with respect to first virtual straight line L1 passing through centroid G2 of second region A2 defined by the outer edge of first optical surface 411 and second virtual straight line L2 perpendicular to first virtual straight line L1. In the present embodiment, first virtual straight line L1 extends in a direction passing through the center of a plurality of ejector pin marks 430, and second virtual straight line L2 extends in a direction perpendicular to first virtual straight line L1.

Further, in the examples shown in FIGS. 7A and 7C, the plurality of ejector pin marks 430 are disposed at positions that are rotationally symmetric (twofold symmetric) with respect to centroid G1 of first region A1. Further, the plurality of ejector pin marks 430 are disposed at positions that are rotationally symmetric (twofold symmetric) with respect to centroid G2 of second region A2 defined by the outer edge of first optical surface 411. In the example shown in FIG. 7B, centroid G1 of first region A1 and centroid G2 of second region A2 coincide with each other.

In the example shown in FIG. 7B, the plurality of ejector pin marks 430 are disposed at positions that are rotationally symmetric (threefold symmetric) with respect to centroid G1 of first region A1. Further, the plurality of ejector pin marks 430 are disposed at positions that are rotationally symmetric (threefold symmetric) with respect to centroid G2 of second region A2 defined by the outer edge of first optical surface 411. In the example shown in FIG. 7B, centroid G1 of first region A1 and centroid G2 of second region A2 coincide with each other.

In the example shown in FIG. 7D, the plurality of ejector pin marks 430 are disposed at positions that are line-symmetric with respect to first virtual straight line L1 passing through centroid G1 of first region A1 and second virtual straight line L2 perpendicular to first virtual straight line L1. Further, the plurality of ejector pin marks 430 may be disposed at positions that are line-symmetrical with respect to first virtual straight line L1 passing through centroid G2 of second region A2 defined by the outer edge of first optical surface 411 and second virtual straight line L2 perpendicular to first virtual straight line L1. In the example shown in FIG. 7D, the plurality of ejector pin marks 430 are disposed at positions that are rotationally symmetric (fourfold symmetric) with respect to centroid G1 of first region A1. Further, the plurality of ejector pin marks 430 are disposed at positions that are rotationally symmetric (fourfold symmetric) with respect to centroid G2 of second region A2 defined by the outer edge of first optical surface 411. In the example shown in FIG. 7D, centroid G1 of first region A1 and centroid G2 of second region A2 coincide with each other.

### (Manufacturing Method of Optical Receptacle)

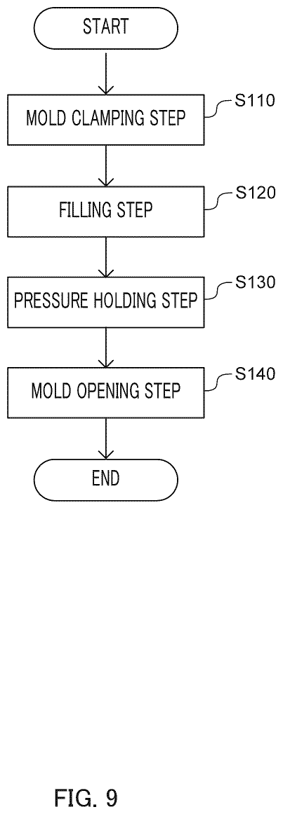

Next, a manufacturing method of optical receptacle 400 will be described. FIG. 8 is a sectional view of a mold. FIG. 9 is a flowchart showing a manufacturing method of optical receptacle 400.

First, mold 500 for manufacturing optical receptacle 400 will be described. Optical receptacle 400, which is an injection molding product, is manufactured using mold 500. The number of inserts of mold 500 is not particularly limited. As shown in FIG. 8, in the present embodiment, mold 500 includes first mold 510, second mold 520, and third mold 530. First mold 510 and second mold 520 are on the movable side and are positioned by angular pin 540. Third mold 530 is on the fixed side.

First mold 510 includes first molding surface 511 for molding a surface side (front surface side) on which second optical surface 412 and third optical surface 413 of optical receptacle 400 are disposed. First mold 510 is a slide core, and positioning recessed portion 512 for forming positioning protrusions 440 is formed in first molding surface 511. Second mold 520 includes second molding surface 521 for molding a surface side (upper surface side) on which reflecting surface 415 is disposed. Third mold 530 includes third molding surface 531 for molding a surface side (bottom surface side) on which first optical surface 411 and the fourth optical surface are disposed and both side surfaces. A plurality of ejector pins 550 are provided around the boundary line of the mold insert corresponding to insert split line 420 such that a force is applied to first region A1 in a balanced manner at the time of demolding. In the present embodiment, since optical surface 410 described in the claims is first optical surfaces 411 and fourth optical surfaces 414, the molding surface described in the claims is third molding surface 531.

As illustrated in FIG. 9, the manufacturing method of optical receptacle 400 includes a step (S120) of filling cavity 501, with a liquid material, the cavity being formed between the fixed side (third mold 530) including third molding surface 531 (molding surface) for molding first optical surface 411 (optical surface 410) including recessed portions 451 and protruding portions 452 and the movable side (first mold 510 and second mold 520), and a step (S140) of obtaining optical receptacle 400 by extruding the solidified material in cavity 501 with a plurality of ejector pins 550 provided in the fixed side (third mold 530). In the present embodiment, in addition to the above-described configuration, a mold clamping step (S110) and a pressure holding step (S130) are further provided.

In mold clamping step (S110), first mold 510, second mold 520, and third mold 530 are clamped to form cavity 501. Cavity 501 has a shape complementary to optical receptacle 400.

In filling step (S120), cavity 501 is filled with a liquid material from a gate (not illustrated). The liquid material is a molten thermoplastic resin, a thermosetting resin before curing, or the like.

In pressure holding step (S130), the molten resin in cavity 501 is naturally cooled while maintaining the pressure, thereby solidifying the liquid material.

In mold opening step (S140), mold 500 is opened to take out optical receptacle 400, which is an injection molding product. In the present embodiment, first mold 510 is slid and second mold 520 is removed in a state where third mold 530 is fixed. Finally, a plurality of ejector pins 550 are pushed into cavity 501 to take out optical receptacle 400 from third mold 530. At this time, ejector pins 550 release optical receptacle 400 at the same time.

By the above steps, optical receptacle 400 is obtained as an injection molding product.

### (Effect)

As described above, according to the present invention, since the optical surface (first optical surfaces 411 in the above-described embodiment) including the recessed portions and the protruding portions is molded by the stationary mold, the position accuracy and the shape accuracy of the optical surface are high.

In the present embodiment, first optical surfaces 411 facing the photoelectric conversion element are optical surface 410, but second optical surfaces 412 facing optical transmission member 300 may be optical surface 410. In addition, third optical surfaces 413 or fourth optical surfaces 414 may be optical surface 410. In a case where optical surface 410 is second optical surfaces 412 and/or third optical surfaces 413, second optical surfaces 412 and third optical surfaces 413 are molded by the fixed side.

### INDUSTRIAL APPLICABILITY

The optical receptacle and the optical module according to the present invention are useful for optical communication using a photoelectric conversion element and an optical transmission member.

### REFERENCE SIGNS LIST

100 Optical module
200 Photoelectric conversion element
300 Optical transmission member
310 Ferrule
400 Optical receptacle
410 Optical surface
411 First optical surface
412 Second optical surface
413 Third optical surface
414 Fourth optical surface
415 Reflecting surface
420 Insert split line
430 Ejector pin mark
440 Positioning protrusion
451 Recessed portion
452 Protruding portion
453 Phase control surface
454 Stepped surface
455 Central portion
500 Mold
501 Cavity
510 First mold
511 First molding surface
512 Positioning recessed portion
520 Second mold
521 Second molding surface
530 Third mold
531 Third molding surface
532 Split molding line
540 Angular pin
550 Ejector pin
A1 First region
A2 Second region
CA1 First central axis
CA2 Second central axis
CA3 Third central axis
CA4 Fourth central axis
G1 Centroid
G2 Centroid
L1 First virtual straight line
L2 Second virtual straight line

1. An optical receptacle for optically coupling a photoelectric conversion element and an end surface of an optical transmission member in a case where the optical receptacle is disposed between the photoelectric conversion element and the optical transmission member, the optical receptacle comprising:
an optical surface for allowing incidence thereon of light emitted from the photoelectric conversion element or the optical transmission member or for causing, to be emitted therefrom toward the end surface of the optical transmission member or the photoelectric conversion element, light having passed through an inside of the optical receptacle, the optical surface including a recessed portion and a protruding portion;
an insert split line disposed to surround the optical surface; and
a plurality of ejector pin marks disposed around a first region defined by the insert split line.

2. The optical receptacle according to claim 1, wherein
a shape of the optical surface is formed by superposition of an aspherical component and a spiral component.

3. An optical module, comprising:
a photoelectric conversion element;
an optical transmission member; and
the optical receptacle according to claim 1, disposed between the photoelectric conversion element and the optical transmission member.

4. A manufacturing method for manufacturing, by injection molding, an optical receptacle including an optical surface including a recessed portion and a protruding portion, the manufacturing method comprising:
filling a cavity with a liquid material, the cavity being formed between a stationary mold and a movable mold, the stationary mold including a molding surface for molding the optical surface including the recessed portion and the protruding portion; and
obtaining the optical receptacle by extruding a solidified material in the cavity with a plurality of ejector pins provided in the stationary mold.
